(19) United States
(12) Patent Application Publication
(10) Pub. No.: US 2002/0065400 A1
(43) Pub. Date: May 30, 2002

(54) Resin material and method of producing same

(76) Inventors: Mikhail Raskin, Stoughton, MA (US); Lazar O. Ioffe, Boston, MA (US); Azariy Z. Pukis, Marlborough, MA (US); Martin H. Wolf, Dedham, MA (US)

Correspondence Address: Mirick, O'Connell, DeMallie & Lougee, LLP, 100 Front Street, Worcester, MA, 01608, US

(21) Appl. No.: 09/826,172

(22) Filed: Apr. 4, 2001

Related U.S. Application Data
(60) Provisional application No. 60/195,073, filed on Apr. 6, 2000.

(51) Int. Cl. C07G 1/00; C08L 97/00

(52) U.S. Cl. 530/500

(57) ABSTRACT

The present invention relates to a new process for modification of lignins, particularly from sulfite waste liquor, and preparation of lignin phenol-formaldehyde resin, i.e. thermosetting resins for which some or all of the phenol is replaced by the modified lignin. The lignin is modified in two steps. In the first step, a graft-copolymerization is performed with different kinds of unsaturated monomers containing carbonyl groups, and in particularly aldehyde groups, and also amido, carbonylic, carboxylic, nitrilic, hydroxylic, acetic, amino, and other functional groups. In the second step, the graft-copolymer is treated with formaldehyde, phenol, phenol-formaldehyde, or a mixture thereof, at elevated temperatures. The obtained modified lignin product is used to produce lignin phenol-formaldehyde resins. These resins can be used as binders in oriented strand board (OSB), particleboard, plywood, and other wood composite products and in industrial resins for electronics, automobiles, appliances, metal castings, abrasives, insulation, refractories and other applications.

### CROSS REFERENCE TO RELATED APPLICATION

This application claims priority from Provisional application 60/195,073, filed on Apr. 6, 2000.

### FIELD OF THE INVENTION

This invention relates to lignin and lignin derivatives and especially a lignosulfonate modified phenol-formaldehyde (PF) resin useful in adhesive compositions for cellulose and cellulose containing materials and more particularly for making OSB, plywood, particleboard, fiberboard, flakeboard, and the like, for use as a binder for insulation, for use in molded objects, and for any application where PF resins are used.

### BACKGROUND OF THE INVENTION

The occurrence of lignin as a waste product in chemical treatment of wood, particularly in the pulp and paper industry, has made it an attractive raw material for adhesives. (Advanced wood adhesives technology. A. Pizzi, Marcel Dekker Inc. New York, Basel, Hong Kong. Vol. 1, 1994, 289 p.p.)

Because of the economy of using technical lignin in PF resins, there have been numerous efforts at the extension of resins with lignins (Lignin-Adhesive research for wood composites. Terry Sellers, Jr. Technical Editor. 1995, Mississippi University).

Lignin is composed of phenylpropane (C9) units that are linked by carbon-to-carbon as well as carbon-to-oxygen (ether) bonds. Because of this structure, condensation reactions in industrial lignin by heat or mineral acids cannot be as effective as in synthetic PF resins, due to the lower number of free position s on the aromatic nuclei of lignin and their considerably lower reactivity. So, lignin in technical spent liquors cannot be as effectively cross-linked as synthetic PF resins.

Lignin can be incorporated into PF-resins in several ways: 1) Lignin or its derivatives can be reacted with formaldehyde to provide methylol functionalities, and then mixed with standard PF-resin; 2); Lignin or its derivatives can be directly reacted or mixed with PF-resin; 3) Lignin or its derivatives can be synthesized with PF-resin; and 4) Lignin or its derivatives can be sequentially synthesized with phenol and formaldehyde to enhance its reactivity in PF-resin.

At the present time, there are reported the following methods of lignin modification to increase its reactivity for substitution of phenol in PF resins:

interaction (treatment) with formaldehyde at various pH;

interaction (treatment) with phenol at various pH:

treatment with formaldehyde and phenol at various pH;

fractionation by molecular size;

utilization as a substitute for phenol while producing a resin;

oxidation of lignin-formaldehyde adducts with air or molecular oxygen;

graft-copolymerization with unsaturated acid, nitrile or amide compounds for use as a surfactant, a scale inhibitor in water treatment applications, or as a soil modifier.

However these graft copolymerized products have not been reported for use as an adhesive.

The first patents dealing with the application of spent sulfite liquor (SSL) as an adhesive for paper, wood and other lignocellulosic materials dates to the end of the nineteenth century.

At the present time several kinds of technical lignins are produced: lignosulfonate, sulfate lignin, hydrolysis lignins, biological lignins, explosive lignins and organosolve lignins.

Lignosulfonate (LS) commonly is used as a generic term for spent sulfite liquor (SSL), lignosulfonate purified by removal of carbohydrates, sulfonated alkali lignin from alkaline pulping processes (e.g. the Kraft process), and sulfonated hydrolysis lignin obtained from wood saccharification. For the purposes of this invention LS refers to SSL or LS purified from SSL.

There are two different ways of utilizing lignosulfonate: as a single component of adhesive, or in a mixture with PF resins. As was shown in the above references, the first way has very strong drawbacks—long curing time, high curing temperature, high acidity, and the necessity of additional treatment after pressing of pressed-wood products. This causes dark color and poor physical-mechanical properties and poor water resistance in composite wood panels made with these substances.

The SSL particleboard obtained by Shen (condensation reaction) cannot be compared technically with exterior-grade PF particleboard (K. C. Shen and L. Calve, Ammonium-based spent sulfite liquor for waferboard binder, Adhesives Age, 25-29 (August 1980), Canadian Patent #2,410,746).

Instead of using a condensation reaction of lignosulfonate, Nirnz suggested using a radical polymerization reaction with hydrogen peroxide. In this case the formation of new carbon-carbon as well as carbon-oxygen bonds between two radicals is very fast and with a low activation energy, thus requiring no external heating or strong mineral acid catalyst. This approach has some drawbacks: high consumption of hydrogen peroxide (9-10%) and dark color (N. H. Nimz and G. Hitze. The application of spent sulfite liquor as an adhesive for particleboard, Cellul. Chem. Technol. 14; 371-382 (1980)).

A second approach is to use lignosulfonate or modified lignosulfonate in a mixture with PF resins.

U.S. Pat. No. 3,017,303 describes the use of purified alkali lignin as a modifier for phenolic plywood resins. U.S. Pat. No. 3,658,638 discloses lignosulfonate as a phenol replacement in adhesive resin made by co-condensing lignosulfonate, phenol and formaldehyde. U.S. Pat. No. 3,864,291 describes a plywood adhesive made by reacting black liquor of the Kraft or soda alkaline pulping processes with formaldehyde and then blending this adduct with phenol-formaldehyde resin. U.S. Pat. No. 4,113,675 similarly describes an adhesive prepared by reacting lignin from Kraft or soda black liquor with a phenol-formaldehyde resin. U.S. Pat. No. 4,303.562 describes an alkali lignin-based adhesive prepared by adding a phenol-water-lignin solution to a partially condensed PF resin and then reacting the mixture under alkaline conditions.

With all of the above methods the low level of lignin reactivity severely limits the relative amount of phenol that can be replaced.

Conventional techniques for modifying or preprocessing lignin into a water-soluble product exist for use as binders in various wood processes. One technique for dissolving lignin is methylolation of lignin such as sulfite lignin. For example, as described in U.S. Pat. No. 4,332,589 of Lin, lignin is methylolated by treatment with formaldehyde under alkaline conditions at a temperature between about 60° C. and about 90° C. The resultant lignin is then acidified to a pH below 7 and heated to a higher temperature. This technique for solution of sulfite lignin is further set forth in U.S. Pat. No. 5,075,402 of Schmitt et al.

U.S. Pat. No. 4,105,606 teaches the removal of the low molecular weight lignin fraction to create an improved substitute for phenol. In this patent “at least 35%, properly over 40% or 45%, and preferably over 50% by weight of the alkali lignins shall have molecular weight in excess of 5000 as determined by gel chromatography.” The authors of this patent suggest application of their invention as an adhesive for the manufacture of plywood, fiberboard, and particleboard, containing a combination of phenol formaldehyde resin and lignin derivatives such as lignosulfonates or alkali lignins. According to the invention a minimum of 65% by weight of lignosulfonates and a minimum of 40% of the alkali lignins have relative molecular weights in excess of that of Glucagon, i.e. 3483 D.

U.S. Pat. No. 4,670,098 describes a pulping process in which the pulping liquid is subjected to ultrafiltration during the pulping operation to remove constituents having a molecular weight above 3500 and most preferably above 1500. The concentrate, with higher molecular weight constituents, after evaporation or spray drying, is useful in the preparation of adhesives. Low molecular weight lignin-containing byproducts obtained by pulping of wood, typically hardwood, in an aqueous ethanolic liquor have been substituted for phenol in PF resins used to bond maple blocks.

McVay, et. al. suggested the use of a low molecular weight lignin fraction of pre-selected molecular weight range prepared from lignin solution by ultrafiltration. They used a fraction of lignin in the range between 50,000 and 2,000 removing lignin with molecular weight higher than 50,000 and low molecular weight less than 2,000, including the main quantity of pulping chemicals and impurities. The separated lignin was treated with formaldehyde preferably with the mass ratio in the range of about 1:3.5 to about 1:2.5 at pH preferably in the range between about 9.6 to about 10.6 and at a temperature preferably in the range of about 60° C. to about 65° C. The complete reaction typically takes from about 50 minutes to about 70 minutes. The hydroxymethylated lignin then is reacted with a quantity of phenol sufficient to complete the activation and copolymerize the lignin into a phenol-formaldehyde resin.

Stephen Y. Lin (U.S. Pat. No. 4,332,589) suggested a two-stage treatment of lignin. In the first stage lignin is reacted with formaldehyde and in the second stage air (or oxygen) is used to increase the molecular weight. The lignin is first treated with from 0.5 to 3.5 moles of formaldehyde per 1000 grams of lignin at a pH between 10.5 and 11.5 and temperature from 50° C. to 80° C. for from 3 to 24 hours to form a lignin formaldehyde adduct preferably with minimum crosslinking of lignin. Then the thus formed lignin formaldehyde adduct is oxidized at a temperature of from 25° C. to 80° C. with air or molecular oxygen for from 2 to 24 hours.

U.S. Pat. No. 4,546,173 describes a method of methylolation of sulfonated lignin suitable for use as dispersants and adhesives. Sulfonated lignins are post-sulfonation crosslinked with a crosslinking agent of an aldehyde, epoxide or polyhalide, at a pH of between about 6.1 to 9, to selectively crosslink the low molecular weight lignins and thus provide improved heat stability and dispersibility of sulfonated lignins in dye compositions.

U.S. Pat. No. 4,701,383 suggests a method for manufacturing a lignosulfonate-phenol-formaldehyde resin by heating a mixture of phenol, formaldehyde, lignosulfonate and alkali at a temperature of 60 to 100° C. and at a pH of 8-13. The lignosulfonate is mixed with phenol and formaldehyde before substantial reaction between them. The manufactured resin can be used as a binder in fiberboard, particleboard, plywood, OSB, and waferboard.

Robert M. Hume et al suggested (U.S. Pat. No. 4,564,649) an aqueous adhesive possessing sufficient adhesion, tack, open time, thermal stability, biological stability, dimensional stability, and flexibility, containing, in an aqueous base, a polyvinyl alcohol and lignosulfonate wherein there are about 1 to 8 parts of the ligninsulfonate per each part of the polyvinyl alcohol.

Thus in principle it has been shown that technical lignin, and particularly SSL or lignosulfonate, can be used for replacing an aminoplast or PF resin in quantities of 10-15% of the base resin without an essential decrease of resin quality. But any replacement with a greater quantity of lignin derivative, as a rule, demands an increased curing time and temperature and a decreased pH. Lower pH reduces the mechanical properties of wood panels and increases emissions of free formaldehyde from urea-formaldehyde resin.

A recent review of the advantages of using lignosulfonate in PF resins is presented by R. F. Bucholze, Glen A. Doering, and Charles A. Whittemore. (Phenol replacement with lignosulfonate: A more effective Method. Adhesives 95. Forest Products Society). These authors described six methods of resin synthesis for phenol-formaldehyde resin (see Table 1).

TABLE 1
Patented methods of phenol substitution with
lignosulfonate-alkaline cooks.

| Author | U.S. Pat. No. | Reaction Sequence |
|---|---|---|
| Herrick | 3,095,392 | Phenol-formaldehyde resole |
| | | (2.0-3.0 F/P) + |
| | | lignosulfonate. |
| Ludwig | 3,658,638 | Phenol + lignosulfonate + caustic + |
| | | heat to form PL precursor then |
| | | formaldehyde to form PLF resole. |
| Coyle | 3,931,072 | Lignosulfonate + formaldehyde + |
| | | heat then phenol-formaldehyde resole. |
| Forss et al. | 4,105,606 | Preformed phenol-formaldehyde |
| | | resole + lignosulfonate and |
| | | formaldehyde together. |
| Hollis Jr. et al. | 4,303,562 | Preformed phenol-formaldehyde |
| | | resole + lignin-phenol |
| | | concentrate and formaldehyde |
| | | and caustic. |
| Janiga | 4,701,383 | Lignin + phenol + formaldehyde + heat. |

U.S. Pat. No. 4,719,291 suggested several modifications of lignin by reacting the liquor with a phenolic compound in the presence of an oxidizing agent. The phenolic compound-modified spent sulfite liquor contains 4-25% reacted phenolic compound based on the dry weight of the original spent liquor. The modified spent sulfite liquor was suitable for use in a thermosetting resin formulation. This reaction used a high temperature (120-160° C.), and the addition of 0.1-1.0 moles of an oxidizing agent per kilogram of solid spent sulfite liquor. The method of this patent is very complicated and uses phenol in greater quantity than lignosulfonate, plus ammonium persulfate, or H₂O₂, or another oxidizing agent to modify the lignosulfonate. Only 4-25% of the phenol reacted with the lignosulfonate. The content of sugars in the SLL decreased at least 20% based on the sugar content of the spent sulfite liquor and numbers of sulfonic acid groups. The vapors of the reaction were distilled and the distillate was added to the product. The pH of the solution after the reaction with oxidizing agent was 3-5, which was necessary for use as an adhesive to replace PF resin.

Glen Doering developed a method for obtaining a modified resole resin using lignin by first reacting formaldehyde and phenol at a mole ratio of formaldehyde to phenol of less than about 1.0 in the presence of alkaline material in an amount sufficient to provide a mole ratio of said alkaline material to phenol between about 0.04 and 0.08 to form precursor resin. The precursor resin was then reacted with lignin to form a lignin-modified phenol-formaldehyde precursor resin. This lignin modified phenol-formaldehyde precursor resin was then reacted with additional formaldehyde sufficient to provide a cumulative formaldehyde to phenol mole ratio of between about 2.0 and about 3.0. This product can replace up to 23% phenol in resins for wood composites.

In Zaslavsky's U.S. Pat. No. 4,276,077, the reagents used are graft polymers obtained from crude lignosulfonate and monomer selected from the group consisting of vinyl cyanide (acrylonitrile), vinyl acetate, hydrolyzed vinyl acetate, acrylamide, or combinations thereof at a pH of between 2 and 6 in the presence of an initiator.

The same substances were used for modification of lignin by Stephen Y. Lin and Lori L. Bushar, U.S. Pat. No. 4,891,415.

S. Lin et al. (U.S. Pat. No. 4,891,415) obtained a graft copolymer of lignin and vinylic monomer using a continuous process wherein the vinylic monomer and a suitable initiator were continuously, but separately, fed to a solution of lignin. The monomer was selected from a group consisting of the general formula RCH═CR′R″ where R and R′ are H, or an alkyl group, and R″ is —COOH, —CN or —CONH2 and the initiator is hydrogen peroxide, an organic peroxide, or persulfate. This continuous method created a copolymer with low viscosity and with more uniform properties as dispersants and scale inhibitors in water treatment applications.

It was shown that not more than 25% of phenol can be replaced by different derivatives of industrial lignin in PF resins without excessive reduction of mechanical qualities and water resistance in composition wood panels made with the resins.

### SUMMARY OF THE INVENTION

The present invention relates to a novel and improved lignin modification, its use in lignosulfonate-phenol-formaldehyde (LPF) resin compositions, and a method for producing such compositions. The invention is a non-toxic, stable composition including in solution about 90-100% parts of methylolated lignin-based materials (e.g. lignosulfonate) and phenol formaldehyde resin, that contains 10-90% graft-copolymer of lignosulfonate.

Utilization of lignin in the production of phenol-formaldehyde resins is of great interest because there is a strong economic incentive to replace as much of the phenol as possible with less costly modifiers that do not detract from resin performance.

To obtain a graft-copolymer of lignin, lignosulfonate or another lignin-based material can be combined with different kinds of alpha, beta-unsaturated monomers containing carbonyl groups, and, in particular, aldehyde groups, but also amidic, nitrilic, carboxylic, hydroxylic, acetic, amino and other functional groups. The preferred unsaturated monomers are unsaturated aldehydes including, acrolein, crotonaldehyde, and others.

The lignin-based materials for graft copolymerisation was primarily ammonium or sodium lignosulfonate from Tembec, Inc., whose properties are summarized in Tables 2 and 3.

TABLE 2
Characteristics of lignosulfonates from Tembec, Inc.

| Tests | A-002 (Ammonium) | S-001 (Sodium) |
|---|---|---|
| Solids, % w/w | 51.5 | 48.3 |
| pH at 25° C. | 4.30 | 7.57 |
| Viscosity at 25° C. (cPs) | 1,225 | 1,009 |
| Free nitrogen, % based on solids | N/A | 0.13 |

Sodium lignosulfonate produced an adhesive with better properties than ammonium lignosulfonate. Calcium lignosulfonate, magnesium lignosulfonate, and also lignosulfonate with mixed bases, were also used herein.

TABLE 3
Detailed analysis of lignosulfonates from Tembec, Inc.
Product Name: S-001
Description: Aqueous sodium lignosulfonate

| Parameter | Unit | Average | % CV | Parameter | Unit | Average | % CV |
|---|---|---|---|---|---|---|---|
| Solids Content | % w/w | 48.3 | 2.6 | Ash Content solids basis | % w/w | 22.3 | 7.5 |
| pH at 25° C. | pH | 7.6 | 2.8 | TOC* | g/L | 214 | 7.0 |
| Specific Gravity at 25° C. | gm/cc | 1.254 | 0.7 | BOD(5)* | g/L | 48 | 16.0 |
| Viscosity at 25° C. | cPs | 759 | 20.9 | COD* | g/L | 757 | 7.8 |
| Free Nitrogen solids | % w/w | 0.24 | 5.1 | Phenolic Compounds* | μg/g | ND | — |
| Phenol Content | μg/g | 0.8 | 31.9 | Fatty and Resin Acids | μg/g | 1,812 | 71.1 |
| Sugars | | | | | | | |
| Arabinose | % w/w | ND | — | Xylose | % w/w | ND | — |
| Galactose | % w/w | ND | — | Mannose | % w/w | ND | — |
| Glucose | %w/w | ND | — | Total | % w/w | ND | |
| Anions | | | | | | | |
| Fluoride (F⁻) | μg/g | <100 | — | Nitrate (NO₃⁻) | μg/g | <100 | — |
| Chloride (Cl⁻) | μg/g | 969 | 31.9 | Phosphate (PO₄⁻³) | μg/g | <500 | — |
| Bromide (Br⁻) | μg/g | <100 | — | Sulfate (SO₄⁼) | μg/g | 8,620 | 38.6 |
| Nitrite (NO₂⁻⁾ | μg/g | <250 | — | | | | |

| Metals* | Unit | Average | % CV | Metals* | Unit | Average | % CV | Metals* | Unit | Average | % CV |
|---|---|---|---|---|---|---|---|---|---|---|---|
| Ag | μg/g | <2 | — | Cu | μg/g | <4 | — | Pb | μg/g | <20 | — |
| Al | μg/g | <20 | — | Fe | μg/g | 23 | 51 | S | μg/g | 32,475 | 10.8 |
| As | μg/g | <40 | — | K | μg/g | 448 | 2.1 | Sb | μg/g | <40 | — |
| Ba | μg/g | 2 | 18.8 | Hg | μg/g | <0.01 | — | Se | μg/g | <40 | — |
| Be | μg/g | <0.2 | — | Mg | μg/g | 108 | 11.1 | Sr | μg/g | 3.21 | 11.3 |
| Bi | μg/g | <40 | — | Mn | μg/g | 47 | 11.2 | Ti | μg/g | <2 | — |
| Ca | μg/g | 559 | 20.5 | Mo | μg/g | <20 | — | V | μg/g | <2 | — |
| Cd | μg/g | <2 | — | Na | μg/g | 34,200 | 4.5 | Zn | μg/g | 4 | 43.0 |
| Co | μg/g | <4 | — | Ni | μg/g | <20 | — | | | | |
| Cr | μg/g | <2 | — | P | μg/g | <40 | — | | | | |

*Sample basis **% CV = 100*Standard Deviation/Average

To obtain water-soluble resins from sulfate lignin or Alcell® lignin, acrylic acid was used for the copolymerization. For this reaction, good mixing of the lignin with acrylic acid was very important because the reaction can occur only in solution. This means it was necessary to use an alkaline medium for the initial reaction, or an organic solvent in which the lignin could be dissolved.

Grafting lignin with unsaturated aldehydes can be carried out using different methods of radical initiation, for example: high temperature, radioactivity, persulfates, diazo compounds, peroxides (in particular hydrogen peroxide), and valence transition metals. In the examples, hydrogen peroxide and ferrous chloride or ferrous sulfate was used. Processes were carried out with temperatures of about 15-80° C. (60-176° F.), a duration of ½-4 hours, and a pH of 3.0-9.5.

Using different quantities of ferrous salts and hydrogen peroxide allowed control of the speed of reaction. Initiators react with the unsaturated monomers to produce free radicals which, in the presence of lignin free radicals, can quench the reaction by capturing the homopolymer radicals. This is termed a “termination reaction”. The extent of the reaction, and the direction of copolymerisation, can be controlled by the quantity of aldehyde charged per unit time, and by the temperature and duration of reaction. The total quantity of aldehyde used influenced the copolymer reactivity. As a rule, between 0 and 10 percent aldehyde was used. See Tables 4 and 12.

When 10% acrolein was used, after methylolation the product had very high viscosity and very high reactivity. If less than 0.2% acrolein was used, after methylolation the resulting material showed only small changes in viscosity and reactivity.

Interestingly, reacting lignosulfonate with only acrolein at the standard condition (30° C.) led to a significant increase in viscosity (molecular weight), and a minor decrease in gelling time (Table 4).

TABLE 4

| | Viscosity, | Gelling time, | |
|---|---|---|---|
| Sample | cPs | 121° C. | Notes |
| Sodium | 1060 | 2750 | PH = 8.2 |
| lignosulfonate | | | |
| #67 | 985 | 2814 | 1% acrolein, pH = 8.33 |
| #65 | 3200 | 2514 | 2% acrolein, pH = 8.34 |
| #71 | 12500 | 2319 | 4% acrolein, pH = 8.35. |

The improved quality (increased reactivity) of the modified lignosulfonate can be seen in Table 5, which shows data for viscosity and pH of the product after 16 days at 50°C.

To further increase the reactivity of the lignin and to mitigate the high cost of unsaturated aldehydes and other organic modifiers, additional methylol groups can be introduced into the graft copolymer by reaction with a small aldehyde (typically formaldehyde), 1-10% by weight, at pH 9-11, temperature 60-100° C., and duration 5-75 minutes. After that, the temperature was decreased to 30° C., the pH decreased to ˜8-10, to obtain the raw end product. The final product has the follow characteristics: viscosity 400-1200 cPs, solid content 43-51%, gel time at 121° C. of 1500-3000 sec., free formaldehyde of up to 2%, storage time at 4° C. of more than 2 months. At high temperatures, the storage time strongly decreases as the activity of the modified lignin increases (Table 5). To increase the storage time at high temperature, free phenol can be added to bind any free formaldehyde. This phenol was utilized for the next step, synthesis of phenol-formaldehyde (PF) resin from the modified lignosulfonate. In some cases, before adding phenol, surplus water and volatile organic substances were removed, in particular formaldehyde, under vacuum. The product was then refrigerated for storage before use as an adhesive or as a resin.

Synthesis of lignin-phenol-formaldehyde (LPF) resin was carried out in three steps:

1. Synthesis of a low viscosity PF precursor with F:P ratio of around 1:1 at a pH not higher than 9 and a temperature of 60-75° C.

2. Reaction of the modified lignosulfonate (L) with the PF precursor. The lignosulfonate may have been modified with any combination of unsaturated carbonyl compound and/or formaldehyde.

3. Polycondensation of the product of step 2 by addition of sodium hydroxide and formaldehyde for an F:(P+L) mole ratio between 1.3:1 and 3:1, at a temperature of 70-90° C., and to a target viscosity and pH consistent with the final resin.

It is possible to reverse the order of reaction to modify the lignosulfonate and produce the resin: in the first reaction, lignosulfonate can be reacted with formaldehyde, and in the second reaction with an unsaturated carbonyl compound. In this case, the second reaction is more easily controlled because it can be carried out at low temperature.

TABLE 5
Effect of temperature on viscosity and pH of samples of modified lignosulfonate.

| | Modifica- | Initial | | Three Days | | Six Days | | Eight Days | | Twelve Days | | Sixteen Days | |
|---|---|---|---|---|---|---|---|---|---|---|---|---|---|
| Sample | tion | Viscosity | pH | Viscosity | pH | Viscosity | pH | Viscosity | pH | Viscosity | pH | Viscosity | pH |
| Na LS | — | 460 | 9.80 | 518 | 9.67 | 582 | 9.54 | 583 | 9.45 | 675 | 9.43 | 725 | 9.40 |
| 618 | Acr. | 1500 | 9.67 | 2225 | 9.38 | 2770 | 9.29 | 3000 | 9.20 | 3450 | 9.14 | 3900 | 9.11 |
| 619 | Crot. | 900 | 9.61 | 1300 | 9.39 | 1750 | 9.33 | 2000 | 9.24 | 2200 | 9.20 | 2400 | 9.10 |
| 621 | Acr.+ F | 760 | 9.06 | 1800 | 8.70 | 12600 | 8.74 | 43000 | 8.63 | 66000 | 8.57 | — | — |
| 622 | Crot + F | 600 | 9.03 | 1425 | 8.78 | 7400 | 8.65 | 19000 | 8.53 | 28500 | 8.47 | 47000 | 8.50 |
| 624 | 621 + Ph | 405 | 8.40 | 545 | 8.32 | 1880 | 8.30 | 3800 | 8.29 | 6900 | 8.28 | 21500 | 8.29 |
| 625 | 622 + Ph | 415 | 8.36 | 580 | 8.28 | 1650 | 8.28 | 2700 | 8.26 | 4500 | 8.24 | 10800 | 8.28 |

Note: Acr. = acrolein; Crot. = crotonaldehyde; F = formaldehyde; Ph = phenol.

From Table 5 it is clear that the activity of the product increases after treatment with 8-10% formaldehyde, as the viscosity of the samples obtained (#621 and 622) is tens of times higher than that of the initial samples (#618 and 619).

Also from Table 5 it is clear that the addition of free phenol (approximately 25% by weight) to samples 621 and 622, to produce samples 624 and 625, sharply decreases the active functional groups of the lignin derivative and decreases its reactivity to that of the initial lignin, even after one week of heating.

It is also clear from Tables 13 and 14 that, for a given quantity of formaldehyde, increasing the quantity of acrolein or crotonaldehyde strongly increases the reactivity of the intermediate product and increases the reactivity of the resulting LPF resin. In Tables 13 and 14, the gel time of samples with increasing quantities of alpha, beta-unsaturated aldehyde is substantially shorter. These data demonstrate the importance of the alpha, beta-unsaturated aldehyde in the two step modification of industrial lignin for the production of LPF resins.

A concern about the use of a natural product, such as lignin, in industrial processes is that the product properties will vary over time. The invention reduces this effect because the active functional groups in the modified lignin are placed there synthetically, thereby allowing control of the product properties. Indeed, five different samples of sodium lignosulfonate (Tembec) were used for the production of LPF resin, and no significant difference in the quality of the LPF resins obtained was observed, nor were any significant variations observed in OSB panels made from these resins.

The inventive lignin derivatives can be use both separately and in mixture with synthetic or natural resins, and in synthesis of different LPF resins. Resins obtained herein were used as adhesives for the production of plywood, particleboard, OSB and in industrial applications. As adhesives for the wood industry, the inventive LPF resins can be applied with conventional spray nozzles or, for plywood and veneers, with a conventional roller. There were no technical problems during synthesis, and up to about 40% by weight of PF resin (equivalent to 70% of the phenol) can be replaced with the inventive modified graft-copolymer of lignin, without loss of quality. No special problems occurred during storage of the inventive resin.

The derivatives of lignin were used in different types of lignin-phenol-formaldehyde (LPF) resins. These LPF resins were used as adhesives for the production of plywood, OSB, particleboard, and industrial applications.

### EXAMPLES

### Example 1

240 g sodium lignosulfonate (Tembec S-001. See Tables 2 and 3) were introduced into a reactor (three-neck flask provided with stirrer, thermometer and condenser) with pH about 8.2. 10 g 50% NaOH and several crystals FeCl₂ were added and dissolved in the aqueous liquid over 15 minutes at room temperature. Then 2.5 ml (0.035M) acrolein was added and mixed for 10 minutes at room temperature. After that ˜1 ml 35% hydrogen peroxide was added and an exothermic reaction was observed. The temperature increased by 2-5° C. The mixture was kept at ˜30° C. for 3 hours. Over the course of this time, about 0.5 ml hydrogen peroxide was added at three separate times. Then 20 g 50% NaOH was added with constant stirring. The temperature increased to 50-60° C. Using an electric heating mantle the temperature was increased to 60-65° C. and 24 ml 37% formaldehyde was added with strong stirring. The temperature was then quickly raised to 95° C. and the mixture held for 5 minutes at that temperature. The mixture was cooled to ˜35° C. The pH was about 9.

The final product was a liquid with viscosity 300-8000 cPs at 25° C. The viscosity of lignin resins has a very strong dependence on concentration and temperature. This fact shows that there is a secondary reversible interaction. The resins obtained in this way were named “Lignophen.”

The graft co-polymer of lignosulfonate (Lignophen) was reacted with a commercial PF-resin, manufactured by Borden Chemical, Inc. for OSB applications. The ratio of Lignophen to PF-resin was varied from 1:4 to 1:1. The reaction mixture was heated from room temperature to about 60° C. over ˜30 minutes at pH 11-12. The effect of this reaction on resin properties is summarized in Table 6.

TABLE 6
Effect of combining Lignophen with
phenol-formaldehyde resins.

| Type of | Lignophen Added, | Gel-time, sec. at | |
|---|---|---|---|
| PF-resin | % | 100° C. | Notes |
| OSB Core | 0 | 860-870 | |
| OSB Face | 0 | 1190-1210 | |
| OSB Core | 20 | 920 | mixing at RT |
| OSB Face | 20 | 1140 | mixing at RT |
| OSB Core | 20 | 860 | cooking at 60° C. |
| OSB Face | 20 | 1120 | cooking at 60° C. |
| OSB Core | 40 | 816 | cooking at 60° C. |
| OSB Face | 40 | 1070 | cooking at 60° C. |
| OSB Face | 50 | 1580 | cooking at 60° C. |

These data show that up to about 40% of the PF-resin can be replaced with Lignophen resin with no significant change in gel time.

### Example 2

An adhesive PF resin was prepared as described in Example 1 and used for the production of plywood. Plywood assembly conditions are given below.

Three-ply plywood panels were constructed with 6-inch square, ⅛-inch Southern Yellow pine veneer. The moisture content (MC) for the control panel was 2-4 percent, and the veneer MC for the lignin-based adhesive test panels varied from 1 to 4 percent. For all experiments a filler (wheat flour) was used equal to 10% by weight of wet resin. The adhesive spread level was ˜44 lb/MSGL. The adhesive was applied to the veneer with a brush. The panel layup conditions were as follows: lay-up time, 2 min, stand time before prepress, 10 min, prepress time, 5 min at 150 psi, at ambient temperature, and stand time after prepress, 10 min. The panels were hot pressed for 3 minutes at 200 psi and 190° C.

These samples were tested according to the Adhesive Policy of the American Plywood Association (01.01.1984). The shear strength was measured before boiling and after boiling for 2 hr. and drying for 20 hr. at 80° C. In all cases the percent wood failure was determined. Results of these tests are given in Table 7.

TABLE 7
Influence of Lignophen on properties of PF resin for plywood
production.

| | Lignophen | Resin | | Before Boil- | After Boiling |
|---|---|---|---|---|---|
| | Added, | Solids, | Viscosity, | ing Wood | Wood |
| Resin ID | % | % | cPs | failure, % | failure, % |
| PF Resin | 0 | 50.3 | 150 | 85 | 90 |
| (Borden) | | | | | |
| LPF-18* | 20 | 49.0 | 355 | 95 | 95 |
| LPF-18* | 20 | 49.0 | 355 | 90 | 95 |
| LPF-30* | 40 | 49.0 | 805 | 90 | 80 |
| LPF-32 | 21 | 46.0 | 770 | 70 | 85 |

*Resins were cooked with resin, manufactured by Borden Chemical, Inc., according to Example 1.

Table 7 shows that replacing from 20 to 40% of PF-resin with Lignophen resin allows the production of plywood panels without loss of panel performance.

### Example 3

In this example a resin containing Lignophen, phenol, and formaldehyde was prepared. In a 3-neck flask with condenser and stirrer was loaded 100-g phenol, 50-ml formaldehyde (37%) and 8 g NaOH (50%). This solution was mixed 15 min and had a pH of 9.15. The temperature was raised to 95° C. for 1 hr. and held for 30 minutes. Then 100 g Lignophen was added and held at 60° C. for 30 minutes. After that an additional 160 ml formaldehyde (37%) was added and the pH adjusted to 10.5 with 50% NaOH. The temperature was increased to about 85° C. and held for 2.5 hr. until a viscosity of 95 cPs was obtained.

After that the pH was increased to 11.7 and the reaction continued for approximately 1 hr. to a viscosity of 175 cPs. After an additional 2.5 hr. at 85° C. the viscosity reached 770 cps. and the reaction was ended. This resin contained 21% Lignophen resin and was identified as LPF-32. It was also used for the manufacture of plywood samples. The method of manufacturing plywood was the same as described in Example 2. Results of testing this resin are also shown in Table 7.

### Example 4

To 600 g of phenol was added 64 g 50% NaOH and the mixture heated to 50° C. with stirring. 480 ml 37% formaldehyde was added. The temperature of reaction was increased to 85° C. over 45 minutes and the concentration of free formaldehyde (FF) observed to decrease to 0.07%.

The material obtained was divided into three equal parts. To each part was added 20, 30, or 40% Lignophen. Then the cooking was continued with the addition of 200 ml 37% formaldehyde, in portions, at 50° C., under weak vacuum. After that was added 50 g 50% NaOH and the reaction kept at approximately 80° C. until the target viscosity was obtained.

The three resins obtained were used to produce plywood panels, which were constructed and tested as described above. As can be seen from Tables 8 and 9, changing the quantity of Lignophen in the LPF resin from 20% to 40% by weight did not adversely influence the quality of plywood produced.

TABLE 8
Influence of Lignophen on quality of LPF resin.

| | Lignophen | Viscosity at | Gel. Time at | |
|---|---|---|---|---|
| Resin ID | added, % | 25° C., cPs | 121° C., sec. | pH |
| LPF-75 | 20 | 2250 | 586 | 10.80 |
| LPF-76 | 30 | 2350 | 559 | 10.80 |
| LPF-78 | 40 | 2700 | 586 | 10.77 |

Note:
Ratio F:P in all experiments was 2.25:1.

As can be seen from the results obtained, incorporating up to forty percent of the phenol-formaldehyde with Lignophen did not adversely influence the quality of resins, nor did it adversely influence the quality of plywood panels produced from those resins, as shown in Table 9. Replacing thirty percent of the phenol-formaldehyde resin with Lignophen is equivalent to replacing fifty-six percent of the phenol with Lignophen.

Thus the suggested method of modification of lignosulfonates will allow replacing of up to 40% of a standard PF-resin by any of several different methods including mixing, cooking, and synthesis with phenol and formaldehyde to produce a new resin.

TABLE 9
Quality of plywood obtained with LPF resin according to Example 4.

| | Sam- | | | | | | | | | |
|---|---|---|---|---|---|---|---|---|---|---|
| | ple | | Press | | | Gel | Shear | Wood | | |
| Resin | Num- | Ratio | Temp | Press | Viscosity, | Time, | Strength | Failure, | | Wood |
| ID | ber | F:P | ° C. | Time | cPs | sec. | kg/sq. in. | % | pH | Specie |
| LPF- | 6 | 2.25:1 | 150 | 3′50″ | 840 | 592 | 97 | 83 | 10.85 | Poplar |
| 60 | | | | | | | | | | |
| LPF- | 21 | 2.25:1 | 150 | 3′50″ | 840 | 592 | 89 | 88 | 10.85 | Poplar |
| 60 | | | | | | | | | | |
| LPF- | 66 | 2.51:1 | 150 | 4′00″ | 1575 | 566 | 93 | 87 | 10.80 | Poplar |
| 3-1 | | | | | | | | | | |
| LPF- | 83 | 2.25:1 | 180 | 4′00″ | 2250 | 586 | 108 | 83 | 10 80 | S. Y. |
| 76 | | | | | | | | | | Pine |
| LPF- | 82 | 2.25:1 | 180 | 4′00″ | 2350 | 559 | 97 | 80 | 10.80 | S. Y. |
| 75 | | | | | | | | | | Pine |
| LPF- | 113 | 2.25:1 | 165 | 4′00″ | 2700 | 586 | 74 | 83 | 10.77 | S. Y. |
| 78 | | | | | | | | | | Pine |
| LPF- | 90 | 2.76:1 | 180 | 4′00″ | 2350 | 374 | 59 | 87 | 10.89 | S. Y. |
| 77-1 | | | | | | | | | | Pine |
| LPF- | 94 | 2.25:1 | 165 | 4′00″ | 1400 | 590 | 77 | 87 | 10.35 | S. Y. |
| 77-2 | | | | | | | | | | Pine |
| LPF- | 104 | 2.51:1 | 180 | 4′00″ | 1375 | 590 | 76 | 83 | 10.81 | S. Y. |
| 77-3 | | | | | | | | | | Pine |
| LPF- | 102 | 2.51:1 | 165 | 4′00″ | 1375 | 590 | 72 | 83 | 10.81 | S. Y. |
| 77-3 | | | | | | | | | | Pine |
| LPF- | 106 | 1.83:1 | 165 | 4′00″ | 1100 | 643 | 81 | 87 | 10.81 | S. Y. |
| 77-4 | | | | | | | | | | Pine |
| LPF- | 107 | 1.83:1 | 150 | 4′00″ | 1100 | 643 | 80 | 73 | 10.81 | S. Y. |
| 74 | | | | | | | | | | Pine |
| LPF- | 105 | 1.83:1 | 150 | 4′00″ | 1100 | 643 | 67 | 85 | 10.81 | S. Y. |
| 74 | | | | | | | | | | Pine |
| Borden | 1 | — | 150 | 3′50″ | 500 | 390 | 98 | 88 | 11.77 | Poplar |
| PF | | | | | | | | | | |
| Borden | 16 | — | 150 | 3′50″ | 500 | 390 | 91 | 86 | 11.77 | Poplar |
| PF | | | | | | | | | | |

### Example 5

In this example resin LPF 45 was obtained using the same method as in Example 3, except the initial quantity of formaldehyde was increased from 50 to 80 ml. The quantity of Lignophen was increased from 100 g to 200 g (replacing 40% of the phenol-formaldehyde resin), and the quantity of formaldehyde in the second reaction step was decreased from 160 to 100 ml. The final resin had a viscosity of 440 cPs, a gel time at 100° C. of 1412 sec., and a pH equal to 11.06. Excess water was removed by vacuum distillation.

The resin was tested at the Advanced Engineered Wood Composites Center at the University of Maine, Orono, Maine under the direction of Professor Douglas J. Gardner. The resin was mixed with water, Glu-X, pecan shell flour (Cocob), and 50% NaOH and used to manufacture 3-ply plywood. Borden Cascophen™ resin for plywood manufacturing was used as a control. Data developed in these tests are presented below in Tables 10 and 11.

TABLE 10
Adhesive formulations for testing plywood.

| Ingredients | Mixing time, min. | Lignophen, g. | Control, g. |
|---|---|---|---|
| Water | | 157 | 155 |
| Glu-X | 5 | 63 | 55 |
| Resin | 5 | 219 | 176 |
| Cocob | 8 | 97 | 91 |
| 50% NaOH | 15 | 44 | 34 |
| Resin | 5 | 420 | 489 |
| Total | | 1000 | 1000 |

Note:
The quantity of water was changed according to the solid content of the resin to obtain the same solids content in the final glue.

TABLE 11
Plywood shear strength results from ASTM D 906 testing (C = control,
L = inventive resin)

| | Load | Wood | | Load | Wood |
|---|---|---|---|---|---|
| Sample ID | (pounds) | failure, % | Sample ID | (pounds) | failure, % |
| C-30-1D | 192.8 | 95 | L-20-1A | 233.2 | 95 |
| C-30-2A | 229.4 | 60 | L-20-1B | 222.4 | 75 |
| C-30-2B | 232.3 | 40 | L-20-1C | 273.9 | 100 |
| C-30-2C | 297.0 | 100 | | | |
| C-30-2D | 318.6 | 95 | | | |
| C-30-3A | 289.7 | 100 | | | |
| C-30-3B | 296.5 | 80 | L-20-1D | 253.6 | 100 |
| C-30-3C | 211.9 | 70 | L-20-2A | 176.1 | 70 |
| C-30-3D | 204.8 | 80 | L-20-2B | 237.1 | 40 |

Notes: The adhesive shear strengths were similar for both control and inventive adhesives (about 209-269 psi for the control, and about 206-259 psi for the inventive adhesive). The difference in strength between open and closed lathe check orientation was approximately 50-100 psi. in both cases.

From Table 11 it is clear that LPF resins containing even 40% by weight of Lignophen resin can be used as an adhesive for the manufacturing of plywood.

### Example 6

The same conditions for synthesis of resin as described in Example 4 were used, but the quantity of Lignophen was constantly 30%, and the ratio of F:P was changed from 1.83:1 to 2.76:1 (LPF 77-1; LPF 77-2; LPF 77-3; and LPF 77-4 were used. See Table 9). No effect on the quality of plywood produced was observed in this experiment.

### Example 7

100 parts by weight (pbw) phenol and 10 pbw 50% NaOH were mixed for 15 minutes. The temperature of the mixture was raised to 50° C., and 87 pbw 37% formaldehyde (preserved with 7-8% methanol) was added in 4-5 parts over 2 hrs. The temperature was gradually increased, over 30 minutes, to about 72-75° C.

The formaldehyde to phenol (F/P) mole ratio of the resulting precursor resin was about 1:1, and the sodium hydroxide to phenol (A/P) mole ratio was about 0.1. The viscosity of the precursor resin was 14-20 cPs, and the pH—was 8.3.

After cooling to 40° C., 150 pbw 48% aqueous Lignophen was added with agitation over a 30 minute interval. The temperature was raised to 70° C. over an 1-hr. interval and was kept there for an additional 30 minutes. The reaction mixture was cooled to about 50° C. and held for about 30 minutes.

The viscosity of the resin obtained was about 40 cPs, the gel time was 2000 sec. at 121° C., and the pH was 8.7.

After heating the reaction resin mixture to 50° C., approximately 130 pbw of additional 37% formaldehyde was added over an 1-hr period. The temperature during this formaldehyde addition was increased to about 70° C. and then raised to 75-80° C. for 1.5 hr. When the viscosity had reached 40 cPs, gel time 1100 sec. and pH 8.6, to the resin was added 10 pbw 50% NaOH. After 30 minutes of reaction the resin had a viscosity of 85 cPs, a gel time of 860 sec., and a pH of 9.2.

The resin was kept at a temperature of 75-80° C. for approximately 2-4 hrs to a viscosity of 1200-1700 cPs and a gel time of 600 sec. Then 35 pbw of 50% NaOH was added.

The final resin had a cumulative F/P mole ratio of about 2.6:1, and formaldehyde to phenol and lignosulfonate (F/(P+L) mole ratio of about 2.1:1 (the lignosulfonate molecular weight was assumed to be 229 g/mol.).

The viscosity of the resin was about 300-400 cPs, the gel time was about 500-600 sec., and the pH was about 10.5-11.5.

The percent replacement of PF resin was 28.6%. The percent replacement of PF resin after removal of water by vacuum distillation was 33%. The percent substitution of phenol was 43%. Oven dry, non-volatile solids were 48-50%.

### Example 8

2400 g of ammonium lignosulfonate (see Tables 2 and 3) were introduced into a reactor (see Example 1) at pH=4.3. 100 g 50% NaOH was added; pH of the solution was 8.22. Then the temperature of the mixture was increased to 50° C. and 240 ml 37% formaldehyde was added with agitation, in three equal portions at 10 minute intervals. The temperature during the 30-40 minutes of formaldehyde addition was increased to about 60-65° C. Over the same time 160 g 50% NaOH was added. The pH of the solution increased to approximately 9.0 and temperature was raised to 80° C. over 40 minutes. After five minutes the temperature of the reaction decreased to less than 60° C. and after 1.5 hr. was only 19° C. To the cold solution was added several crystals of FeCl₂ which dissolved over 15 minutes with stirring. Then 12 g of crotonaldehyde (equaling 1%) was added with intensive agitation over 15 minutes. After that 1 ml of 35% hydrogen peroxide was added and a weak exothermic reaction was observed.

The mixture was kept at 30° C. for 3 hours. During this time hydrogen peroxide was added three times, about 0.5 ml each time. The final product was identified as Lignophen 613, which had the parameters summarized in Table 12. Samples 614 and 615 were prepared using the same conditions but the quantity of crotonaldehyde was increased to 2% and 4%, respectively.

TABLE 12
Properties of Lignophen-Crotonaldehyde.

| Sample | Solids | Viscosity, | Gel time, | | Crotonalde- |
|---|---|---|---|---|---|
| Number | content | cPs | 121, sec | pH | hyde, % |
| 613 | 43.0 | 90 | 1938 | 8.53 | 1 |
| 614 | 43.5 | 122 | 2169 | 8.03 | 2 |
| 615 | 43.4 | 172 | 2203 | 7.49 | 4 |

### Example 9 (Resins 98, 99, and 100)

These resins were synthesized under the same conditions as in Example 1, but acrolein was replaced by crotonaldehyde in the amount of 1, 2 and 4% of the weight of lignosulfonate used. Test results are shown in Table 13.

### Example 10 (Resins 108, 108-1, 108-2, and 108-3)

These resins were synthesized under the same conditions as in Example 3, but after completion of the reaction various quantities of urea were added (see Tables 14 and 15).

### Example 11 (Resin #93)

624 g phenol, 70 g water and 56 g 50% NaOH were introduced into a reactor (see Example 1) and agitated for 15 minutes. The temperature was increased to 50-60° C. over 20 minutes and 387 ml 50% formaldehyde was added in three equal portions at 10 minute intervals. After this 775 g of Lignophen, obtained according to Example 1 (except the acrolein was replaced with an equivalent quantity of crotonaldehyde), and 202 g 50% NaOH were added with agitation over 30 minutes; pH of the solution was 9.5. The temperature was kept at 65-70° C. and 670 g 50% formaldehyde was added in three equal portions at 15 minute intervals. After this, the temperature was raised to 80-85° C. over 10-15 minutes, and maintained for 1.5-2.0 hours, to a viscosity of 250-300 cPs. In this period the pH of the solution increased from 9.5 to 9.9.

The temperature was decreased to 65-70° C., and 25 g 50% NaOH was added. The temperature was maintained until the viscosity of the solution reached 490-500 cPs (gel time 560 sec).

After cooling the reaction mass to 50° C., 520 g urea was added with strong agitation for 30 minutes. The final product had a viscosity of 135 cPs and gel time of 594 sec (121° C.). The product thus obtained was tested in the production of OSB. The results are shown in Tables 13 and 14.

### Example 12 (Resin #94)

This resin was synthesized using the same conditions as in the Example 11, but crotonaldehyde was replaced by acrolein in the amount of 2% of the weight of lignosulfonate (according to Example 1). The final product (Resin #94) had the following characteristics: viscosity, 470 cPs; gel time, 520 sec. at 121° C.

After cooling, 520 g urea was added to the resin. The viscosity was then 121 cPs, and the gel time 545 sec. at 121° C., and pH 10.18.

The results of analysis and testing in the production of OSB are shown in Table 13.

### Example 13

This resin was synthesized using the same conditions as in Example 1, but sodium lignosulfonate was replaced with calcium lignosulfonate (Lignosite, Georgia-Pacific Corporation).

The characteristics of this product (LPF 89) are shown in Table 13 and the properties of OSB produced with this resin are shown in Table 14.

TABLE 13
Conditions of synthesis and properties of various LPF resins.

| | | | | | Vis- | | | PF Re- |
|---|---|---|---|---|---|---|---|---|
| | | | | | cos- | | | sin Re- |
| | Ratio | Alde- | Urea, | LS, | ity, | G.T. | | placed, |
| Resin ID | F:P | hyde | % | Base | cPs | Sec. | pH | % |
| LPF-87 | 2.58:1 | Acr | 15 | Na | 161 | 560 | 10.73 | 30% |
| LPF-88 | 2.58:1 | Acr | 15 | Na | 140 | 619 | 10.62 | 30% |
| LPF-89 | 2.58:1 | Acr | 15 | Ca | 170 | 862 | 10.1 | 30% |
| LPF-92 | 2.58:1 | Cro | 15 | Na | 110 | 615 | 10.48 | 30% |
| LPF-93 | 2.58:1 | Cro | 15 | Na | 135 | 594 | 10.1 | 30% |
| LPF-94 | 2.58:1 | Acr | 15 | Na | 121 | 545 | 10.18 | 30% |
| LPF-95 | — | Acr | — | Na | 160 | 586 | 10.08 | 30% |
| LPF-96 | — | Acr | — | Na | 160 | 545 | 10.08 | 30% |
| | | (4%) | | | | | | |
| LPF-97 | — | Acr | — | Na | 155 | 641 | 9.97 | 30% |
| | | (1%) | | | | | | |
| LPF-98 | 2.25:1 | Cro | 15 | Na | 152 | 712 | 9.86 | 30% |
| LPF-99 | 2.25:1 | Cro | 15 | Na | 142 | 763 | 9.95 | 30% |
| | | (1%) | | | | | | |
| LPF-100 | 2.25:1 | Cro | 15 | Na | 143 | 670 | 9.96 | 30% |
| | | (4%) | | | | | | |

TABLE 14
Properties of OSB panels, manufactured with different resins.

| | | | | | Water | Water | Thickness | Thickness | |
|---|---|---|---|---|---|---|---|---|---|
| | | Press Time, | Press Temp. | IB | Absorption, | Absorption. | Swell, | Swell, | |
| Resin ID | Sample ID | minutes | ° C. | kg/cm² | 2 hr., % | 24 hr., % | 2 hr., % | 24 hr., % | Notes |
| LPF-87 | 17 | 2.5 | 215 | 4.1 | | | | | — |
| LPF-87 | 18 | 3.0 | 215 | 4.7 | 88 | 89.5 | 48 | 18.1 | No wax |
| LPF-87 | 19 | 30 | 215 | 4.8 | 88 | 90.3 | 51.4 | 18.5 | Core, Face #87. |
| | | | | | | | | | No wax |
| LPF-88 | 39 | 2.5 | 215 | 4.9 | — | 18.4 | — | 6.7 | — |
| LPF-89 | 29 | 2.5 | 219 | 5.0 | | | | | — |
| LPF-89 | 41, 42 | 3.0 | 215 | 5.2 | — | 19.4 | — | 8.3 | — |
| Cascophen | 38 | 2.5 | 215 | 5.8 | — | 18.4 | — | 8.3 | — |
| LPF-88 | 52, 50 | 2.5 | 215 | 5.9 | — | — | — | 8.4 | — |
| LPF-88 | 47, 48 | 3.5 | 215 | 5.5 | — | 22.8 | — | 10.9 | Core, Face #88 |
| LPF-92 | 70 | 2.5 | 215 | 5.2 | | | | | — |

Note: Cascophen OS-33B (Borden Chemical, Inc.) was used as the core resin in all examples in Table 14, unless noted otherwise.

TABLE 15
Influence of urea on properties of LPF resin and OSB panels made
with said resin.

| | | | | | Thickness | Water |
|---|---|---|---|---|---|---|
| | | Viscosity, | Gel Time, | | Swell, | Absorption, |
| Resin | Urea, | cPs | seconds | | 24-hour, | 24-hour, |
| ID | % | @25° C. | @121° C. | IB, psi | % | % |
| 108 | 0.0 | 475 | 352 | — | — | — |
| 108-1 | 5.5 | 360 | 505 | 46.5 | 10.1 | 29.2 |
| 108-2 | 11.0 | 240 | 535 | 53.5 | 11.9 | 30.2 |
| 108-3 | 16.0 | 158 | 540 | 54.5 | 13.7 | 31.3 |

### Examples 14 and 15

These resins were synthesized under the same condition as in Example 1, but acrolein was used in quantity 1 and 4% by weight. The results are shown in Table 13.

### Example 16

Lignophen 586 was synthesized according to Example 1. This was used to prepare Resin 66 according to Example 4 (30% replacement of PF resin). Resin 66 had a viscosity of 3450 cPs and a pH of 10.98. It was observed that the viscosity and gel time of the resin and of Lignophen strongly depend on pH (see Table 16).

TABLE 16
Influence of pH on viscosity and gel time of resins.

| Sample# | pH | Viscosity, cps. | Gel time, at 121° C. |
|---|---|---|---|
| 66 | 11.0 | 3450 | 522 |
| 66 | 11.6 | 465 | 620 |
| 66 | 11.9 | 115 | 986 |
| 586 | 8.02 | 407 | 1793 |
| 586 | 6.84 | 475 | 1823 |
| 586 | 5.60 | 575 | 1533 |
| 586 | 4.67 | 690 | 1200 |

### Example 17

50 g Kraft lignin (Indulin AT, Westvaco) was added to a beaker with 2.2 g NaOH in 150 ml distilled water. 2 ml 35% hydrogen peroxide and 4 ml acrylic acid were added at a temperature of 20-30° C. A product was obtained that was soluble in weak alkaline media.

After adding an additional 21 ml acrylic acid, a Kraft lignin derivative that was soluble in acid media was obtained. Both these products could be used for reaction with alpha, beta-unsaturated aldehydes and formaldehyde to obtain derivatives of Kraft lignin for synthesis of lignin-phenol-formaldehyde resins. The synthesized resin had a viscosity of 172 cPs and a gel time of 489 sec.

In another experiment, 50 g Kraft lignin (Indulin AT, Westvaco) was dissolved in 350 ml distilled water with 2 g NaOH in a 1-liter flask with stirring. After mixing, 30 ml acrylic acid, 5 g acrylamide, and 4 ml 35% hydrogen peroxide at 30° C. were added. This product was treated with alpha, beta-unsaturated aldehyde and formaldehyde to obtain a derivative suitable for synthesis of LPF resins. The synthesized resin had a viscosity of 152 cPS and a gel time of 619 sec.

Other embodiments will occur to those skilled in the art and are within the scope of the following claims.

What is claimed is:

1. A lignin-based resin material, comprising the reaction product of a lignin-based material and an alpha, beta-unsaturated carbonyl compound to produce a first reaction product.

2. The resin material of claim 1, wherein the carbonyl compound comprises an aldehyde.

3. The resin material of claim 1, produced by the further reaction of the first reaction product with a different aldehyde.

4. The resin material of claim 3, wherein the different aldehyde is formaldehyde.

5. The resin material of claim 1, wherein the reaction takes place at a pH between 3 and 10.5.

6. The resin material of claim 1, wherein the reaction takes place at a temperature between 15 and 90° C.

7. The resin material of claim 1 wherein the reaction takes place using a radical initiator.

8. The resin material of claim 4, wherein the further reaction takes place at a pH between 8 and 10.5.

9. The resin material of claim 4, wherein the further reaction takes place at a temperature between 60 and 99° C.

10. The resin material of claim 4, wherein the further reaction takes place over a duration of 5 to 360 minutes.

11. The resin material of claim 1, wherein the lignin-based material comprises spent sulfite liquor (SSL).

12. The resin material of claim 1, wherein the lignin-based material comprises Kraft lignin.

13. The resin material of claim 1, wherein the lignin-based material comprises organosolve lignin.

14. The resin material of claim 1, wherein the lignin-based material comprises lignosulfonate.

15. The resin material of claim 14, wherein the lignin-based material comprises one or more lignosulfonates having one or more cations selected from the group of cations consisting of ammonium, sodium, magnesium, calcium, barium and aluminum.

16. The resin material of claim 2, wherein the alpha, beta-unsaturated aldehyde is acrolein or a derivative thereof.

17. The resin material of claim 16, wherein the acrolein or derivative is present at about 0-10% by weight.

18. The resin material of claim 2, wherein the alpha, beta-unsaturated aldehyde is crotonaldehyde or a derivative thereof.

19. The resin material of claim 18, wherein the crotonaldehyde or derivative is present at about 0-12%.

20. The resin material of claim 1, wherein the carbonyl compound comprises an unsaturated amide.

21. The resin material of claim 3, wherein the two reactions are carried out sequentially, in situ.

22. The resin material of claim 1, wherein the lignin-based material comprises a lignosulfonate substantially free of polysaccharides.

23. The resin material of claim 1, wherein the reaction is carried out in a water-methanol medium.

24. The resin material of claim 7, wherein the radical initiator is selected from the group consisting of a redox system of H₂O₂—Fe (II), a system of hydrogen peroxide, azo-compounds, organic peroxides and persulfates.

25. The resin material of claim 2 further comprising the addition of 0-20% urea or urea-formaldehyde resin to the reaction mixture.

26. The resin material of claim 3, for use as an adhesive for particleboard, plywood, fiberboard, flakeboard, oriented strand board, waferboard, laminated veneer lumber (LVL), and other wood compositions.

27. The resin material of claim 2, further comprising reacting with one or more acrylic or methacrylic monomer, and wherein the ratio of the total of the aldehyde and acrylic or methacrylic monomer, together, to the lignin-based material, is in the range of 1 to 25%.

28. The resin material of claim 26, wherein the adhesive curing time is decreased by reducing the pH to less than 6 using a catalyst.

29. The resin material of claim 28, wherein the catalyst is an acidic mineral compound, or mixture thereof selected from the group consisting of NH₄Cl; (NH₄)₂SO₄; Al₂(SO₄)₃; CaCl₂; FeCl₂; ZnCl₂; maleic acid; malonic acid; oxallic acid and p-toluenesulfonic acid.

30. The resin material of claim 3, further comprising drying the final product to a powder, using drying conditions sufficient to accomplish drying without condensation of the resin components during drying.

31. The resin material of claim 3 produced by a first reaction of the lignin-based material and the carbonyl compound to produce a first reaction product, followed by a second reaction of the first reaction product with the other aldehyde to produce a second reaction product.

32. The resin material of claim 3 produced by a first reaction of the lignin-based material and the other aldehyde to produce a first reaction product, followed by a second reaction of the first reaction product with the carbonyl compound to produce a second reaction product.

33. The resin material of claim 3, further comprising mixing the resin material with a phenol-formaldehyde resin.

34. The resin material of claim 3, further comprising using the resin material in a phenol-formaldehyde production process.

35. The resin material of claim 34 wherein the production process takes place with a catalyst selected from the group of catalysts consisting of NaOH, NH₄OH, a salt of a divalent metal, and an amine.

36. The resin material of claim 34 carried out at least in part under vacuum with distillation to alter the solid content of the resin.

37. The resin material of claim 34 wherein spray drying is used to convert the liquid resin to a resin powder.

38. The resin material of claim 34, wherein said resin material is present in an amount of up to about 80% by weight of the final product.

39. The resin material of claim 34, together with phenol-formaldehyde copolymer to make the final product.

40. A method of producing a lignin-based resin material, comprising:
providing a lignin-based material;
providing an alpha, beta-unsaturated carbonyl compound;
providing formaldehyde;
reacting in a first reaction the lignin-based material with one of the alpha-beta unsaturated carbonyl compound and the formaldehyde, to create a first intermediate reaction product; and then
reacting in a second reaction the first intermediate reaction product with the other of the alpha-beta-unsaturated carbonyl compound and the formaldehyde, to create the resin material.

41. The method of claim 40 further comprising:
providing phenol;
providing formaldehyde;
reacting together in a third reaction the phenol and formaldehyde, to begin a phenol-formaldehyde reaction; and
while the third reaction is proceeding, adding to the reaction mixture the resin material, to produce a final material.

42. The method of claim 40 further comprising:
providing phenol-formaldehyde copolymer; and
reacting in a third reaction the resin material and the copolymer, to produce a final material.

43. The method of claim 40 further comprising:
providing a phenol-formaldehyde resin;
mixing the resin material with the phenol-formaldehyde resin to create an adhesive mixture; and
applying the mixture to wood material, to assist in the adhesion of the wood material.

44. The method of claim 40 further comprising the addition of 0-20% urea or urea-formaldehyde resin to the reaction mixture.

45. The method of claim 40, wherein the adhesive curing time is decreased by reducing the pH to less than 6 using a catalyst.

46. The method of claim 45, wherein the catalyst is an acidic mineral compound, or mixture thereof selected from the group consisting of NH₄Cl; (NH₄)₂SO₄; Al₂(SO₄)₃; CaCl₂; FeCl₂; ZnCl₂; maleic acid; malonic acid; oxallic acid and p-toluenesulfonic acid.

47. The method of claim 40, for use as an adhesive for particleboard, plywood, fiberboard, flakeboard, oriented strand board, waferboard, laminated veneer lumber (LVL), and other wood compositions.
